(19) United States
(12) Patent Application Publication
(10) Pub. No.: US 2006/0280883 A1
(43) Pub. Date: Dec. 14, 2006

(54) Wound sandwich tube with corrugated shell

(75) Inventor: Johannes Wilhelmus van de Camp, Hartsville, SC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Sonoco Development, Inc.

(21) Appl. No.: 11/152,583

(22) Filed: Jun. 14, 2005

(51) Int. Cl. B32B 27/10

(52) U.S. Cl. 428/34.2

(57) ABSTRACT

A wound paperboard tube, a winding core, and methods for making same, wherein one or more corrugated plies are included in the tube wall so as to achieve a greater effective thickness per unit volume of material, and thereby reduce the cost per unit volume. In accordance with one embodiment of the invention, a winding core comprises a radially outer zone comprising at least two contiguous, non-corrugated plies wrapped one upon another about an axis and adhered together; a radially inner zone comprising at least two contiguous, non-corrugated plies wrapped one upon another about the axis and adhered together; and a radially intermediate zone comprising at least one corrugated ply having corrugations that are parallel to the axis. The intermediate zone of the winding core can include a plurality of corrugated plies that are contiguous, with corrugations of the contiguous corrugated plies nested in each other.

### BACKGROUND OF THE INVENTION

The present invention relates to wound tubes, and in particular embodiments relates to winding cores for winding rolls of sheet materials and other products.

Wound tubes are used for a variety of applications, including tubular container bodies, as well as winding cores about which sheet materials such as paper, plastic film, metal foil, and the like, are wound into rolls. In the case of winding cores, it is common for a customer to specify the desired dimensions of a core for a particular application, including the inside and outside diameters of the core. The particular application, however, may not require a core of great strength, and a core formed from even the lowest grade of available paperboard materials may still be considerably stronger than it needs to be in order to meet the strength requirement. Cost savings could be realized if the amount and cost (or cost per unit volume) of material could be reduced.

### BRIEF SUMMARY OF THE INVENTION

The present invention addresses the above needs and achieves other advantages, by providing a wound paperboard tube, a winding core, and methods for making same, wherein one or more corrugated plies are included in the tube wall so as to achieve a greater effective thickness per unit volume of material, and thereby reduce the cost per unit volume. In accordance with one embodiment of the invention, a winding core comprises a radially outer zone comprising at least two contiguous, non-corrugated plies wrapped one upon another about an axis and adhered together; a radially inner zone comprising at least two contiguous, non-corrugated plies wrapped one upon another about the axis and adhered together; and a radially intermediate zone comprising at least one corrugated ply having corrugations that are parallel to the axis.

In certain advantageous embodiments of the invention, the intermediate zone of the winding core includes a plurality of corrugated plies that are contiguous, with corrugations of the contiguous corrugated plies nested in each other.

Either or each of the outer shell and the inner shell can include at least three contiguous non-corrugated plies.

In a method in accordance with one embodiment of the invention, a winding core is produced by:
(a) advancing each of at least two non-corrugated plies toward a cylindrical mandrel, and spirally winding the non-corrugated plies one upon another about the mandrel at a spiral wind angle to form an inner shell on the mandrel;
(b) advancing at least one corrugated ply toward the mandrel and spirally winding each corrugated ply about the inner shell at said spiral wind angle, each corrugated ply having corrugations that form an angle relative to longitudinal edges of the ply equal to the spiral wind angle such that the corrugations are parallel to a longitudinal axis of the mandrel;
(c) advancing each of at least two non-corrugated plies toward the mandrel, and spirally winding the non-corrugated plies one upon another about the corrugated ply or plies to form an outer shell; and
(d) wherein adhesive is applied to facing surfaces of the plies to adhere them to one another.

Each corrugated ply can either be drawn from a roll of corrugated ply material, or can be drawn from a roll of non-corrugated ply material that is passed through an inline corrugator on its way to the mandrel. The corrugator is operable to form corrugations at an oblique angle relative to the ply edges, such that the corrugations are parallel to the mandrel axis.

The present invention enables a wound tube or winding core to be constructed with a wall thickness that substantially exceeds the sum total of the calipers of the plies making up the core. Accordingly, the core can meet specified inside and outside diameters in a cost-effective manner in those cases when the strength demands do not require a solid wall.

The invention also enables a wound tube or winding core to be constructed to have a cushion wall, by virtue of the corrugated ply or plies, which can be useful in applications in which cushioning is desired.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a perspective view of a wound tube in accordance with one embodiment of the invention;

FIG. 2 is a cross-sectional view through the tube, along line 2-2 in FIG. 1;

FIG. 3 is a diagrammatic view of an apparatus and process for making a wound tube in accordance with an embodiment of the invention; and

FIG. 4 is a cross-sectional view along line 4-4 in FIG. 5, showing details of an inline corrugating unit.

### DETAILED DESCRIPTION OF THE INVENTION

The present inventions now will be described more fully hereinafter with reference to the accompanying drawings, in which some but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

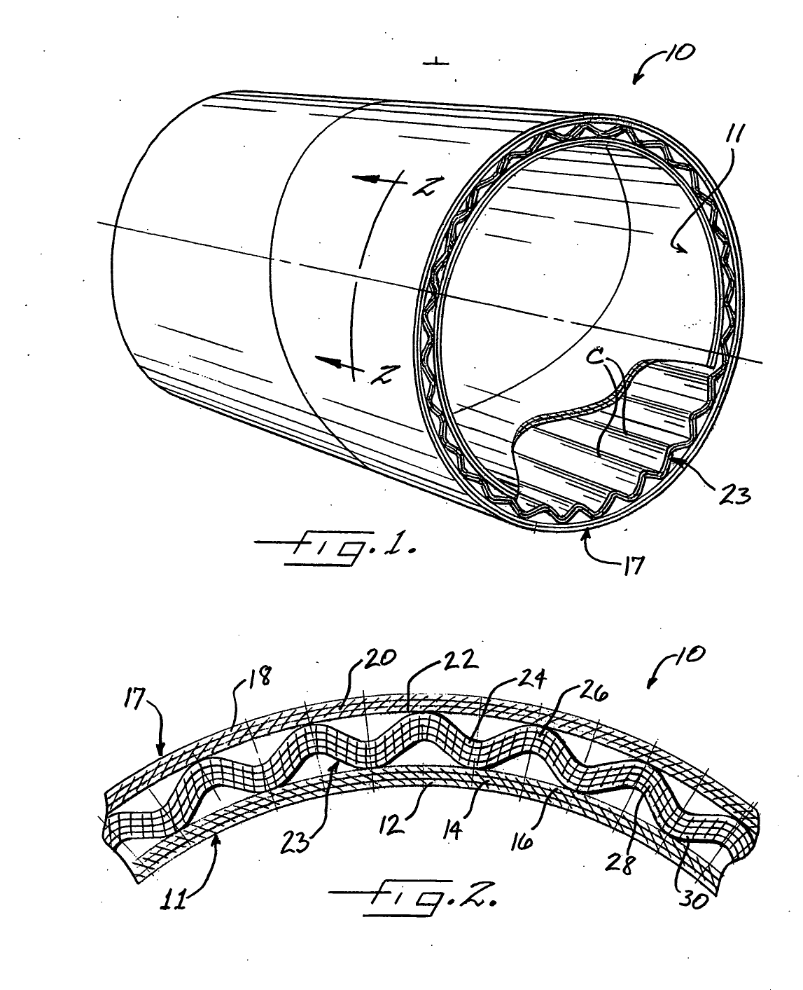

FIGS. 1 and 2 show a wound tube 10 in accordance with one embodiment of the invention. The tube includes a plurality of plies spirally wound one upon another and adhered together. More particularly, the tube includes inner plies 12, 14, 16 that are non-corrugated and contiguous with each other and are adhered together by adhesive applied between the facing surfaces of the plies so as to form an inner zone 11 of the tube wall. The tube also includes outer plies 18, 20, 22 that are non-corrugated and contiguous with each other and are adhered together by adhesive applied between the facing surfaces of the plies so as to form an outer zone 17 of the tube wall. Although three plies are shown in each of the inner and outer zones of the tube wall in FIG. 2, alternatively a different number of plies can be used in either or both zones. However, generally at least two non-corrugated plies are in each of the inner and outer zones.

The tube wall also includes a radially intermediate zone 23 comprising at least one corrugated ply having corrugations C that are parallel to the axis of the tube. In FIG. 2, the intermediate zone is shown as including four corrugated plies 24, 26, 28, 30, but various numbers of corrugated plies can be included. When two or more contiguous corrugated plies are included in the intermediate zone, the corrugations C of one ply advantageously are nested with the corrugations of each adjacent corrugated ply as shown in FIG. 2.

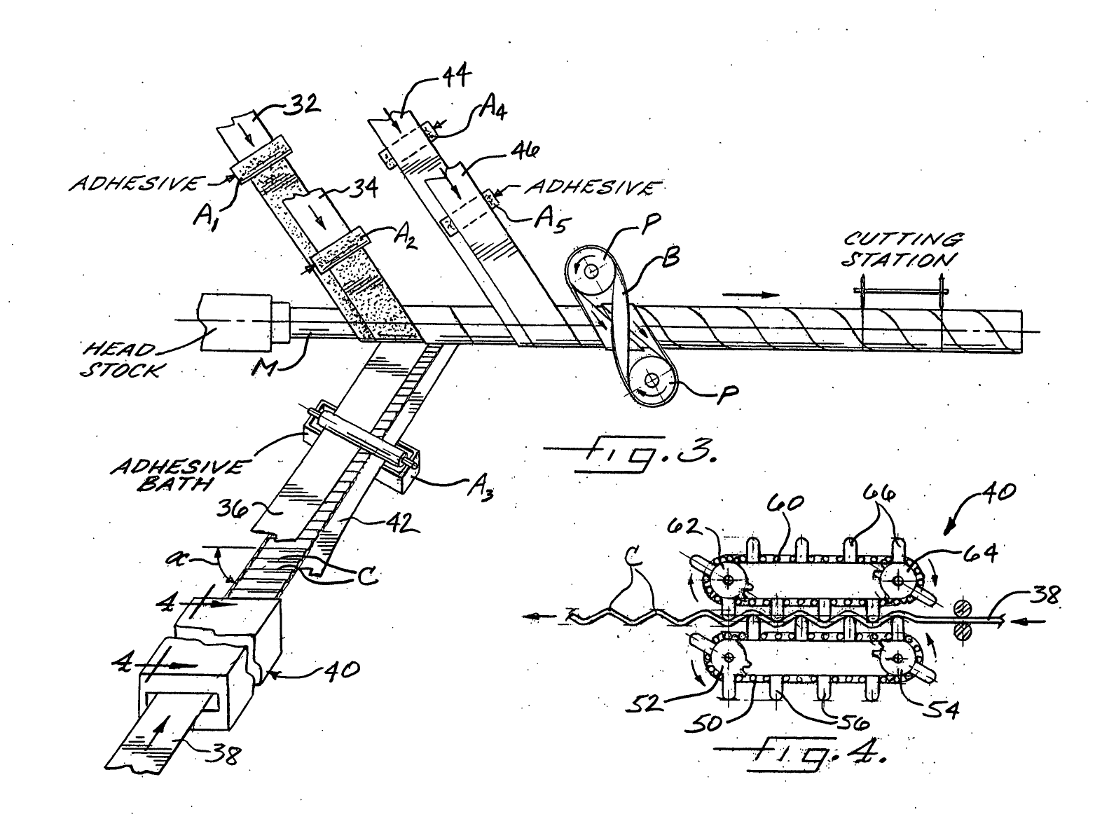

A process and apparatus for making a spirally wound tube in accordance with one embodiment of the invention are depicted in FIGS. 3 and 4. The apparatus includes a stationary cylindrical mandrel M about which plies are spirally wound and adhered together to form a tube on the mandrel. The tube is advanced in screw fashion along the mandrel by a winding belt B that wraps about the tube and is driven by a pair of rotating drums or pulleys P. The advancement of the tube along the mandrel draws the plies from their respective supply rolls and causes the plies to be spirally wrapped about the mandrel. In the process illustrated in FIG. 3, a tube is shown being constructed from a total of seven plies.

More particularly, non-corrugated plies 32, 34, and 36 are drawn from their respective supply rolls and are wrapped about the mandrel one atop another. Adhesive is applied to the outward-facing surface (i.e., the surface facing away from the mandrel) of the innermost ply 32 by a suitable adhesive applicator A₁. Similarly, adhesive is applied to the next ply 34 by a suitable adhesive applicator A₂. The next ply 36 is passed through an adhesive bath A₃ on its way to the mandrel. The result is that plies 32, 34, 36 are adhered together when they are wrapped about the mandrel, thus forming an inner zone of the tube to be formed.

Next, a non-corrugated ply 38 is drawn from its supply roll and is passed through an inline corrugator 40, which is structured and arranged to form corrugations C extending across the width of the ply at an angle, relative to the longitudinal edges of the ply, equal to the spiral winding angle α at which the ply is wound about the mandrel. Accordingly, the corrugations run parallel to the axis of the mandrel and therefore are not subject to being bent and crushed as the ply is wrapped about the mandrel. The corrugated ply 38 is passed through the adhesive bath A₃ before it is wrapped about the mandrel. The corrugated ply 38 forms an intermediate zone of the tube wall.

Finally, a plurality of non-corrugated plies 42, 44, 46 are drawn from their respective supply rolls and are wrapped about the mandrel to form an outer zone of the tube wall. The ply 42 is passed through the adhesive bath A₃ before it is wrapped about the mandrel. The ply 44 has adhesive applied to it by a suitable applicator A₄, and the ply 46 has adhesive applied to it by a suitable applicator A₅. The resulting tube formed on the mandrel can be cut into desired lengths at a downstream cutting station as shown.

FIG. 4 schematically depicts one suitable type of inline corrugator 40 that can be used in the practice of the invention. The illustrated corrugator comprises a first chain arrangement having a pair of endless chains 50 (only one shown in FIG. 4) each looped about sprockets 52, 54 such that the two chains form loops that are spaced apart and parallel to each other. Attached to the chains and extending between them are a series of bars 56 that are spaced apart about the chain loops by a uniform distance equal to one wavelength of the corrugations to be formed in a ply. The corrugator also includes a substantially identical second chain arrangement having a pair of endless chains 60 (only one shown in FIG. 4) each looped about sprockets 62, 64 such that the two chains form loops that are spaced apart and parallel to each other. This second chain arrangement is located above the first chain arrangement. Attached to the chains 60 are bars 66 that are spaced about the chain loops by one wavelength of the corrugations to be formed, but the bars 66 are staggered by half a wavelength relative to the bars 56 of the first chain arrangement, and the bars 56 on the upper chain run of the first chain arrangement at least partially overlap (in the vertical direction) with the bars 66 on the lower chain run of the second chain arrangement. A ply 38 is passed between the two chain arrangements, in a direction that forms an angle (equal to the spiral winding angle at which the ply will be spirally wound in the tube-forming process) relative to the direction in which the chains run. As a result, the ply is deformed by the bars 56, 66 such that corrugations C are formed in the ply. The corrugations run at an angle to the longitudinal edges of the ply.

When more than one corrugated ply is to be incorporated into a tube construction, each ply can be passed through its own inline corrugator. The corrugators can be synchronized relative to one another such that the various corrugated plies have their corrugations in proper positions to nest (as shown in FIG. 2) when the plies are wound onto the mandrel.

The apparatus and process illustrated herein are merely exemplary of one possible way to form spirally wound tubes in accordance with the invention, and variations of course are possible. For example, while the corrugated ply is shown being wound onto the mandrel upstream of the winding belt, alternatively one or more corrugated plies can be wound onto the mandrel downstream of the winding belt so that they are not subject to crushing from the belt. Additionally, various types of adhesive applicators other than adhesive baths can be used. Furthermore, while one type of inline corrugator has been described, the invention is not limited to such a corrugator, and other devices and processes for forming corrugations can be used instead.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A winding core for winding a roll of sheet material, the winding core formed as a spirally wound paperboard tube having a wall comprising:
a radially outer zone comprising at least two contiguous, non-corrugated plies wrapped one upon another about an axis and adhered together;
a radially inner zone comprising at least two contiguous, non-corrugated plies wrapped one upon another about the axis and adhered together; and
a radially intermediate zone comprising at least one corrugated ply having corrugations that are parallel to the axis.

2. The winding core of claim 1, wherein the intermediate zone comprises a plurality of corrugated plies that are contiguous, with corrugations of the contiguous corrugated plies nested in each other.

3. The winding core of claim 1, wherein the intermediate zone includes a narrow corrugated ply that is substantially narrower than the plies of the outer and inner shells such that gaps are defined between adjacent edges of the narrow corrugated ply.

4. The winding core of claim 3, wherein the intermediate zone includes a plurality of contiguous, narrow corrugated plies.

5. The winding core of claim 1, wherein the inner shell includes at least three contiguous non-corrugated plies.

6. The winding core of claim 1, wherein the outer shell includes at least three contiguous non-corrugated plies.

7. The winding core of claim 1, wherein each of the outer shell and the inner shell includes at least three contiguous non-corrugated plies.

8. A wound paperboard tube, comprising:
a plurality of plies spirally wound about an axis one upon another and adhered together to form a tubular wall encircling the axis, wherein the plurality of plies include at least two contiguous corrugated plies having corrugations that extend parallel to the axis, with the corrugations of each corrugated ply nested in the corrugations of an adjacent one of the corrugated plies.

9. The wound paperboard tube of claim 8, wherein the tube includes at least one non-corrugated ply.

10. The wound paperboard tube of claim 8, wherein the tube includes at least two contiguous non-corrugated plies.

11. The wound paperboard tube of claim 8, wherein the tube includes a first zone of at least two contiguous non-corrugated plies and a second zone of at least two contiguous non-corrugated plies, and the at least two corrugated plies are disposed between the first and second zones.

12. A method for making a spirally wound tube, comprising the steps of:
(a) advancing each of at least two non-corrugated plies toward a cylindrical mandrel, and spirally winding the non-corrugated plies one upon another about the mandrel at a spiral wind angle to form an inner shell on the mandrel;
(b) advancing at least one corrugated ply toward the mandrel and spirally winding each corrugated ply about the inner shell at said spiral wind angle, each corrugated ply having corrugations that form an angle relative to longitudinal edges of the ply equal to the spiral wind angle such that the corrugations are parallel to a longitudinal axis of the mandrel;
(c) advancing each of at least two non-corrugated plies toward the mandrel, and spirally winding the non-corrugated plies one upon another about the corrugated ply or plies to form an outer shell; and
(d) wherein adhesive is applied to facing surfaces of the plies to adhere them to one another.

13. The method of claim 12, wherein step (b) comprises drawing at least one non-corrugated ply from a supply roll thereof toward the mandrel, and prior to step of spirally winding, passing each non-corrugated ply through an inline corrugator operable to form the corrugations.

14. The method of claim 12, wherein step (b) comprises drawing each corrugated ply from a supply roll thereof and advancing and spirally winding each corrugated ply.

15. The method of claim 12, wherein step (b) comprises winding a plurality of corrugated plies in contiguous relation with one another such that corrugations of each corrugated ply nest in corrugations of an adjacent one of the corrugated plies.

16. A method for making a wound paperboard tube, comprising the steps of:
spirally wrapping a plurality of plies about an axis one upon another and adhering the plies together to form a tubular wall encircling the axis, wherein the plurality of plies include at least two contiguous corrugated plies having corrugations that extend parallel to the axis, and wherein the at least two corrugated plies are wrapped such that the corrugations of each corrugated ply nest in the corrugations of an adjacent one of the corrugated plies.
